(19) United States
(12) Patent Application Publication
(10) Pub. No.: US 2007/0186720 A1
(43) Pub. Date: Aug. 16, 2007

(54) Case for car start motor

(76) Inventor: Hyun-Bok Lee, Daegu (KR)

Correspondence Address: JHK LAW, P.O. BOX 1078, LA CANADA, CA, 91012-1078, US

(21) Appl. No.: 10/598,977

(22) PCT Filed: Mar. 10, 2005
(86) PCT No.: PCT/KR05/00680

§ 371 Date: Sep. 15, 2006

(30) Foreign Application Priority Data
Mar. 18, 2004 (KR) 20-2004-0007516

(51) Int. Cl. F02N 15/06; F16H 57/02

(52) U.S. Cl. 74/606 R; 74/7 B

(57) ABSTRACT

Discloses is a case which houses an amateur assembly generating a torque in a car start motor, characterized in that: the case is formed so that it is divided into an inner tube and an outer tube, and the inner tube and the outer tube are firmly coupled to each other by forced fitting and fixed holes of the outer tube are inserted into through holes of the inner tube, thereby keeping a firm coupling state. The case enables it easy to manufacture and can reduce manufacturing time as well as cost since the case for the start motor is manufactured in a separate type.

### BACKGROUND OF THE INVENTION

1. Field of the Invention

The present invention relates to a case for a car start motor which can reduce manufacturing time.

2. Description of the Background Art

Generally, a start motor is that receives the power of a battery by turning a start key and ignites a stopped engine, which is often a “Seru motor” at a job site. Such a start motor receives the power of a battery for starting up the engine and rotate by a pinion gear a ring gear 52 of a fly wheel fixed to an outer end of a crank shaft 51 of the engine, which makes the crank shaft rotatable, thereby allowing a piston to perform admission stroke and compression stroke.

FIG. 1 is a view showing a sectional view of a structure of a conventional start motor.

A typical start motor 50 comprises an amateur assembly 10 generating a torque, a driver assembly 20 rotating a ring gear 52 of an engine by the torque transferred from the amateur assembly 10, and a solenoid 30 controlling a pinion 21 of the driver assembly 20 and engaging it with the ring gear 52.

Meanwhile, the conventional amateur assembly 10 constituting such a start motor is provided inside with a case 1 for housing an amateur shaft 11, an amateur core 12, an amateur coil 13, a rectifier 14, a brush 15 and so on, though not indicated by reference numerals

However, the shape of this case 1 is finished through an NC machine by being solid-drawn by a thick tube and finished, that is, the outer diameter thereof is finished by turned finishing, so it takes as much machining time to thus cause excessive manufacture time overall, and increase material cost due to excessive turned finishing for finishing the shape of the case.

### SUMMARY OF THE INVENTION

Therefore, the present invention is designed to overcome the conventional problems, and it is an object of the present invention is to provide a case for a car start motor which is easy to manufacture and can reduce manufacturing time as well as cost since the case for the start motor is manufactured in a separate type.

To accomplish the above object, there is provided a case which houses an amateur assembly generating a torque in a car start motor according to the present invention, characterized in that: the case is formed so that it is divided into an inner tube and an outer tube, and the inner tube and the outer tube are firmly coupled to each other by forced fitting and fixed holes of the outer tube are inserted into through holes of the inner tube, thereby keeping a firm coupling state.

### BRIEF DESCRIPTION OF THE DRAWINGS

In the drawings:

FIG. 1 is a view showing a sectional view of a structure of a conventional start motor; FIG. 2 is an exploded perspective view showing a structure of a case according to the present invention;

FIG. 3 is a sectional view showing the case according to the present invention when coupled; and

FIG. 4 is a perspective view showing a structure of a case according to one embodiment of the present invention.

### DETAILED DESCRIPTION OF THE PREFERRED EMBODIMENTS

A preferred embodiment of the present invention will now be described in detail with reference to the accompanying drawings.

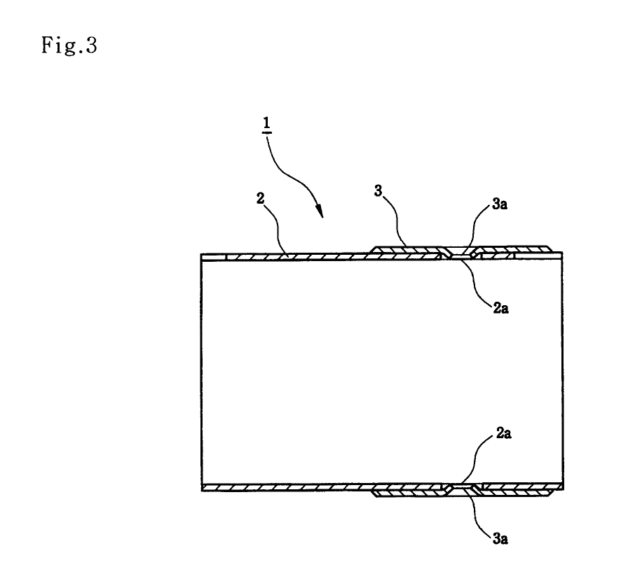

FIG. 2 is an exploded perspective view showing a structure of a case according to the present invention. FIG. 3 is a sectional view showing the case according to the present invention when coupled.

The present invention relates to a case 1 which houses an amateur assembly 10 generating a torque in a car start motor, particularly, improves the structure of case 1 so as to reduce cost and manufacture time.

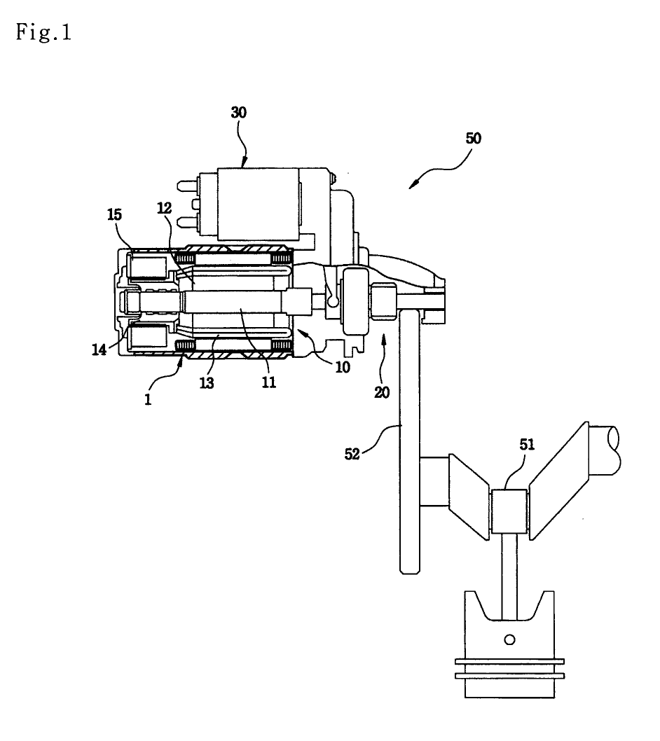

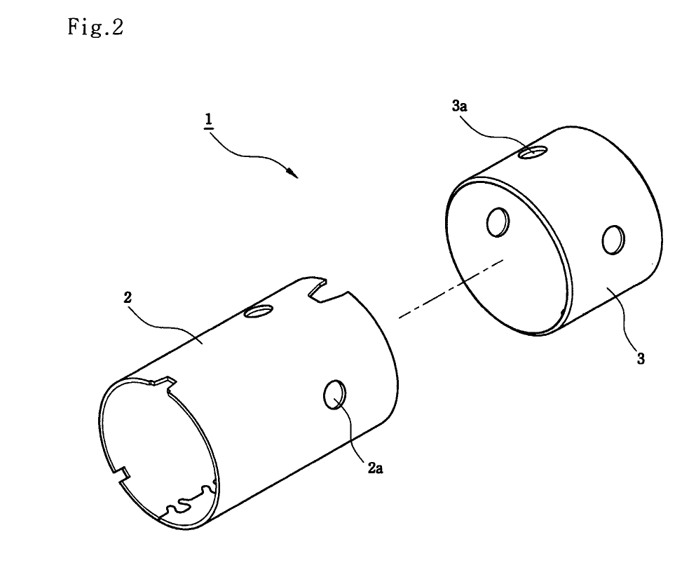

The case 1 according to the present invention is formed so that it is divided into two tubes as shown in FIG. 2. That is to say, the case 1 is manufactured in a manner that an inner tube 2 and an outer tube 3 are separately processed unlike in the conventional art. Subsequently, the processing is easy as compared to integral processing of a conventional case as in FIG. 1, and the manufacture time as well as the cost can be reduced.

The inner tube 2 and outer tube 3 of the case 1 are firmly coupled to each other by force fitting, and axed holes 3a of the outer tube 3 are inserted into through holes 2a of the inner tube 2 so that they can be kept firmly coupled to each other. On the other hand, the through holes 2a and fixed holes 3a formed on the outer peripheral face of the inner tube 2 and outer tube 2 are formed simultaneously when the tubes are processed. Preferably, the fixed holes 3a of the outer tube 3 are smaller in size than the through holes 2a of the inner tube 2.

Consequently, the inner tube 2 and outer tube 3 are coupled to each other by forced fitting as shown in FIG. 3, and the fixed holes 3a of the outer tube 3 are positioned at the through holes 2a of the inner tube 2. Afterwards, the fixed holes 3a of the outer tube 3 are extended, i.e., the fixed holes 3a are inserted into the through holes 2a as being extended thereto.

Accordingly, the fixed holes 3a are inserted and fixed into the through holes 2a, respectively, with the inner tube 2 and outer tube 3 of the case 1 being double-coupled, i.e., coupled to each other by forced fitting. Hence, the outer tube 3 is fixed to the inner tube 2 in such a way as not to fall out without rotating on the inner tube 2, thereby keeping a firm coupling state.

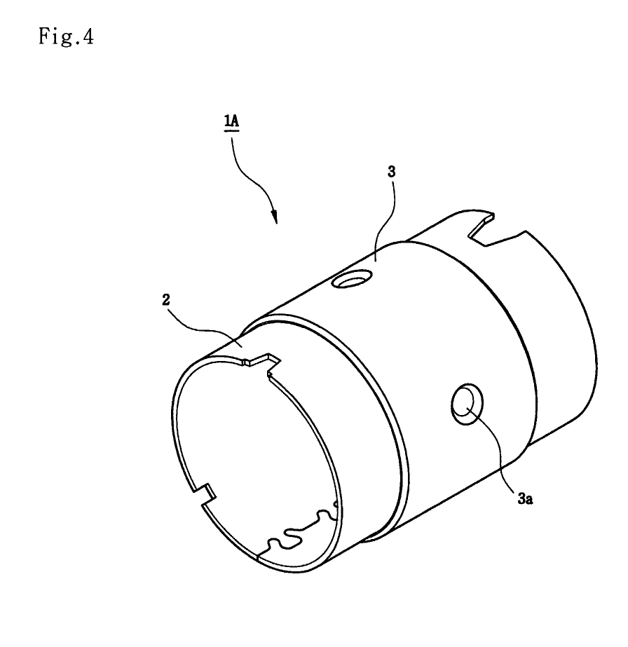

FIG. 4 is a perspective view showing a structure of a case according to one embodiment of the present invention.

The case 1A according to the embodiment of the present invention is characterized in that the position of the outer tube 3 on the inner tube 2 is changeable. In other words, the outer tube 3 of the case 1A is positioned at the center of the inner tube 2.

The construction of the case 1A is the same as above, and the construction of two tubes, the way they are coupled to each other and the operation are the same as above. Except the position of the through holes 2a and fixed holes 3a formed on the inner tube 2 and outer tube 3 is changed. Here, the same reference numerals as those in the above-said drawing denote the same members having the same functions and the operation thereof is identical to those members, so the description thereof is omitted.

In this way, the present invention can make processing relatively easy and reduce manufacturing time as well as cost by manufacturing the case 1 and 1A of the start motor by processing the inner tube 2 and the outer tube separately, rather than by processing the case integrally in the conventional art.

While the invention has been described herein in terms of the preferred embodiments, it is understood that numerous variations may be made without deviating from the idea and scope of the invention, which is apparent to those skilled in the art. These changes and variants may be made without exceeding the spirit and scope of the invention and appended claim given below.

What is claimed is:

1. A case which houses an amateur assembly generating a torque in a car start motor, characterized in that:
the case is formed so that it is divided into an inner tube and an outer tube, and the inner tube and the outer tube are firmly coupled to each other by forced fitting and fixed holes of the outer tube are inserted into through holes of the inner tube, thereby keeping a firm coupling state.
